(19) United States
(12) Patent Application Publication
(10) Pub. No.: US 2007/0098371 A1
(43) Pub. Date: May 3, 2007

(54) Multimedia learning system with digital archive

(76) Inventor: Wen-Chen Huang, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/262,714

(22) Filed: Nov. 1, 2005

(51) Int. Cl. H04N 7/26

(52) U.S. Cl. 386/112

(57) ABSTRACT

The present invention relates to a multimedia learning system with digital archives, in which all lecture notes and audio/video data are integrally stored and controlled with the time axis and the semi-structured language, i.e., extensive markup language (XML). The user can access the audio/video data from the archives with log files of XML codes. These data comprise audio/video data in various media servers, slides, Html data, and audio/video data presented at proper timing. By means of the archives of the present invention, the original status during lecturing is presented. The user can also search the corresponding audio/video data by inputting keywords which will be compared with the audio/video data through the server. Moreover, subjects related to the videos playing can be shown for the user skipping to.

### BACKGROUND OF THE INVENTION

1. Field of the Invention

The present invention relates to a multimedia learning system with digital archives, in which an efficient and convenient audio/video (AV) technology is particularly applied, so that the slides or notes used during lecturing, dialogs between the teacher and students and images thereof can be processed for being conveniently utilized.

2. Related Prior Arts

Currently, many audio/video (AV) systems such as JoinNet, Centrac and NetMeeting, are developed, some of which can even be simultaneously shared by sixteen persons. However, these systems do not provide the function of storing real states with motions and speeches. For example, JoinNet includes an interactive tutoring board for the teacher to write thereon and broadcast to all, a control panel with functions of counting number of members and voting on line, real-time discussion groups, etc. However, during the process of storing AV data, only the teacher's tutoring is recorded without interaction between the teacher and students. For data search of JoinNet, a certain chapter or section can be selected by the user through hyper link and played from the start point thereof.

The real-time AV technologies have been widely applied to e-learning and video conferences which both concern similar conditions and utilize similar techniques. Though many commercial softwares are noted with the function of real-time recording, in fact, only images and voices are recorded regardless time sequence. That is, the real states can not be re-presented or conveniently searched according to these systems, and the users can not efficiently review or find the desired information.

Current real-time recoding technologies are almost not satisfied. For example, JoinNet can store AV data but images will be destroyed and seriously distorted during compacting at a compact rate of 10 MB/sec. In general, users are not interested in such videos with pausing frames and discrete images. In addition to images and voices of the host and participators, lecture notes and slides are also important for users but can not be presented by means of these conventional AV systems.

### SUMMARY OF THE INVENTION

Accordingly, the present invention provides a multimedia learning system with digital archives, in which an efficient and convenient audio/video (AV) technology is applied, so that the slides or notes used during lecturing, dialogs between the teacher and students and images thereof can be processed for being conveniently utilized. In other words, all lecture notes and AV data can be integrally stored in this system, and further controlled with XML semi-structured language and the time axis. When the user accesses AV data from the archive, the log file in the XML format will read all related data including AV data in different servers, slides and Html data, and AV data presenting at certain points of time. By means of the instant archive technique, the real state of lecturing can be re-presented and even searched by inputting keywords. The server will automatically compare all AV data with the keywords, and then subjects at certain points of time related to the current AV data will be shown. Therefore, the video interesting to the user at certain points of time can be directly played without playing da capo.

### BRIEF DESCRIPTION OF THE DRAWINGS

FIG. 1 shows the storage of data structure in accordance with the present invention;

FIG. 2 shows the XML format in accordance with the present invention;

FIG. 3 shows the time axis in accordance with the present invention;

FIG. 4 shows crossover of genes in accordance with the present invention;

FIG. 5 shows the counter in accordance with the present invention;

FIG. 6 shows the searching mechanism in accordance with the present invention;

FIG. 7 shows operation of the system in accordance with the present invention.

### DETAILED DESCRIPTION OF THE PREFERRED EMBODIMENTS

First, the system of the present invention comprises a structure prototype system data, time axis, log files along the time axis, a counter and genetic algorithm (GA). The structure prototype of system data provides a programmer required files for clearly storing real states in the system. The log files along time axis are in XML format, so that the system may communicate with other machines. The counter records events occurring at certain points of time. The time axis assists different works to be executed simultaneously. For example, at a certain point of time, two persons are speaking and one person is writing notes on an electrical white board, and these motions can be simultaneously played for users through operation of the time axis and the counter.

Structure Prototype of System Data

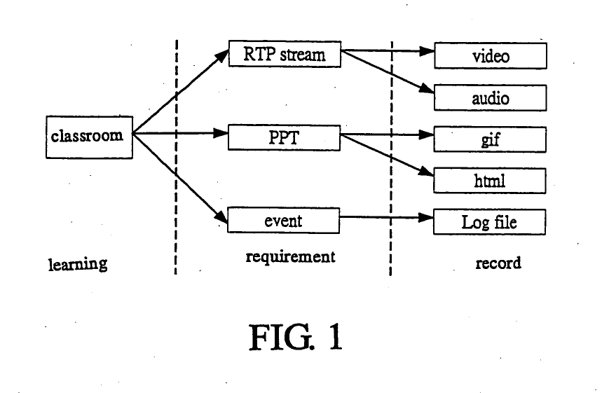

FIG. 1 indicates a process of transferring the real states of lecturing to data structure. In this embodiment, images and voices are recorded with real-time transport (RTP) streams, slides are made with Microsoft Power Point (PPT), and behaviors of users are defined as the events of the system. These data are eventually stored in video, audio, gif, html and log files.

Log File Along Time Axis

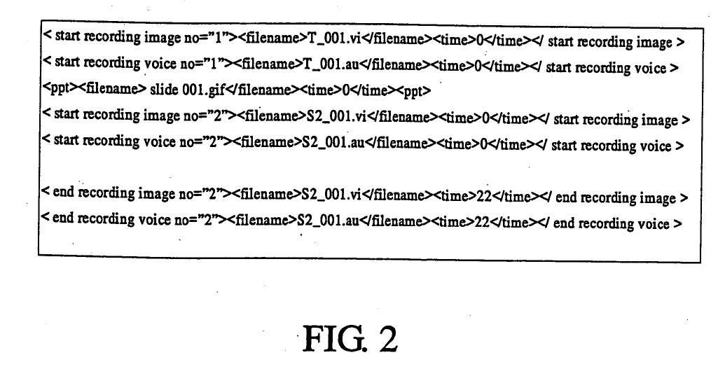

Referring to FIG. 2, the log files are recorded in XML format and comprise all motions of all participators; for example, pushing a button “speaking”, or a series of reactions of the server as receiving instructions “record” or “next slide”.

Time Axis

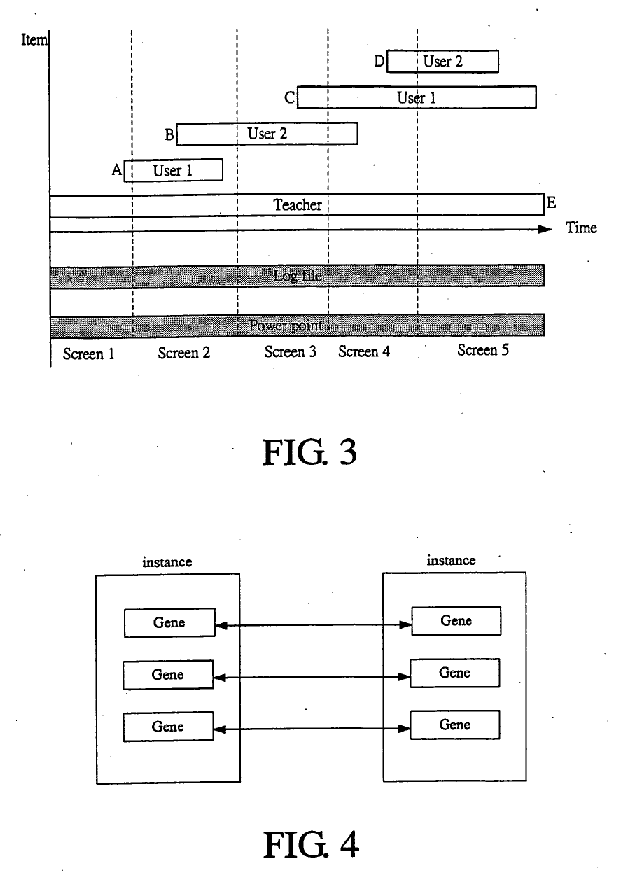

In FIG. 3, items are indicated on Y-axis and a time sequence is indicated on X-axis. The time segments for playing slides or record files are shown beneath the X-axis, and time segments (A, B, C, D and E) for executing AV data files are shown above the X-axis. Vertical phantom lines between screens indicate the time to change slides. FIG. 3 also indicates that the AV data files will be divided when changing slides. For example, the file A and the file D will be respectively composed of two portions, the file B and the file C will be respectively composed of three portions, and the file E will be composed of five portions. In Screen 1, Teacher and User 1 are playing; in Screen 2, Teacher, User 1 and User 2 are playing; in Screen 3, Teacher, User 2 and User 1 are playing; and in Screen 4, Teacher, User 2 and User 1 are playing. In Screen 5, Teacher, User 1 and User 2 are playing. Particularly, User 2 is not necessarily the same one present in the two portions thereof, but a channel for real-time transporting AV data. FIG. 3 shows two files of User 1, two files of User 2 and one file of Teacher, which all represent channels for real-time transporting AV data. In general, the Teacher channel is used only by a specific person, and the other channels may be used by any of the students. Therefore, the two segments of User 1 in FIG. 3 could be different students. For each of the files, the points of time for starting and ending are marked in the log file, and can be triggered by the counter to begin playing video.

Optimizing Parameters of RTP/RTCP by Means of GA

1. Bandwidth of real cables of an AV server=X
2. A set of video parameters={encoding, frame, size}

a. encoding={JPEG, H263}

b. frame={1, 5, 10, 12, 25, 30}

c. size={160*120, 176*144, 320*240}
3. Encoding of audio={Linear, G723 }
4. Bandwidth provided for each user to speak=Uᵢ

Uᵢ={(encoding, frame, size), (encoding)}×(n+1)

wherein n is the number of teachers and students.
5. The least total bandwidth provided by the AV server=T, i.e., fitting function.

priority=1, Uᵢ is defined as Aᵢ, m is the number of teachers

priority=0, Uᵢ is defined as Bⱼ, k is the number of students

$$n = m + k$$

$$T = {\sum }_{i = 1}^{n} {U}_{i} = {\sum }_{i = 1}^{m} {A}_{i} + {\sum }_{j = 1}^{k} {B}_{j}$$

6. The first condition for optimization is β;

$$X \geq T \geq 0.8 X \\ ⇒ 1.25 \geq \frac{T}{0.8 X} \geq 1 \\ ⇒ 1.25 \geq β \geq 1$$

When β approaches 1, the optimal solution is found, but β=1.25 indicates overload of the real bandwidth of the AV server and is not allowed; and

when β beyond the range 1.25˜1, a second solution β<1 is acceptable.
7. The second condition for optimization is a which should satisfy teacher's bandwidth−student's bandwidth=a>0; or Aᵢ−Bⱼ=a>0.
8. Parameters for each user are expressed with 7 bits, {video encoding, frame frame frame, size size, audio encoding}

Spatial values without specific meaning will be re-assigned randomly.
9. Practical Operation

a. Randomly selecting 7 bits for Uᵢ, wherein former m bits are assigned to Aᵢ, and the other are assigned to Bⱼ; and

b. Defining each combination of encoding and size, and calculating the bandwidth based on a frame per second.

For a two-dimensioned array defined as follows:

| JPEG, | JPEG, | JPEG, |
|---|---|---|
| 320 * 240 | 176 * 144 | 160 * 120 |
| H263, | H263, | H263, |
| 320 * 240 | 176 * 144 | 160 * 120 |

a. Defining numbers of persons for respective Uᵢ;

b. Calculating T,
(encode_size[encoding][size]×frame[frame_number]+audio)×(person+1);

c. Determining β, if β>1.25, this gene will be deleted as it's unsuitable;

d. Recording all Aᵢ and Bⱼ;

e. Making crossover and mutating with a mutation rate 0.5 for frame and size; if β<1, mutating directly without crossover and returning to step d until finding p optimal values through Y generations of crossover; and

f. Selecting the optimal set of parameters from records.
10. Crossover of Genes

Referring to Fig.4, a main body or an instance represents a set of parameters of the AV server, in which parameters used by each user are contained. FIG. 4 indicates exchanging of partial genes between two instants during crossover.

Counter

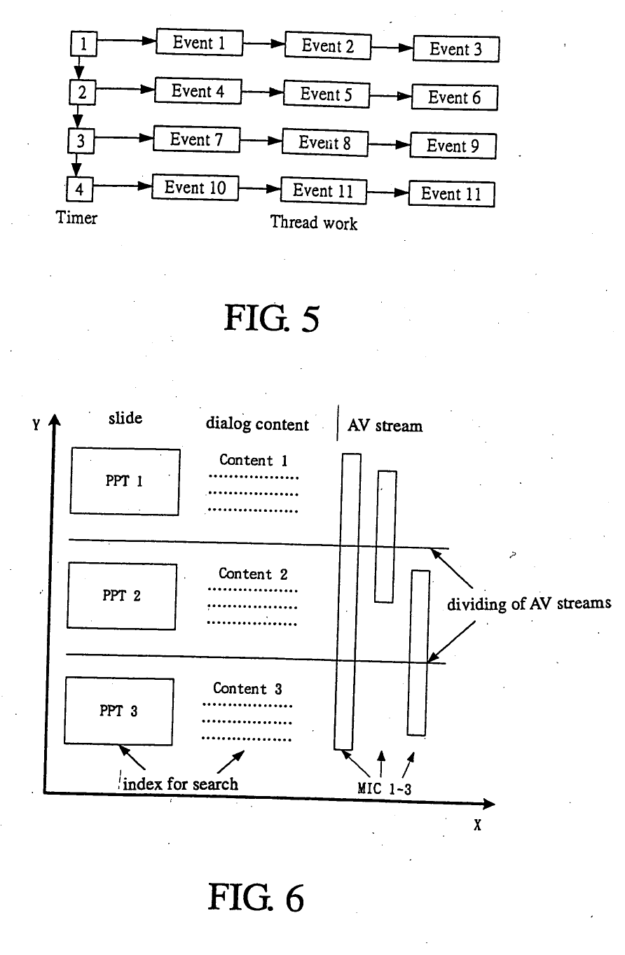

Referring to FIG. 5, a vertical linked list indicates points of time. There could be more than one or no event on each point of time. Once the counter counts to the certain point of time, events loading thereon will be executed through an independent thread.

Searching and Indexing of Images

Referring to FIG. 6, in the coordination, less Y values indicate later video sections, i.e., Y value of PPT 1 is larger than that of PPT 2; and less X values indicate more important indexing contents, i.e., higher correlation to AV streams. Practically, only PPT files and dialog contents are indexed, and correlation of PPT files is higher than that of dialog. In the preferred embodiment of the present invention, audio recognition is not applied due to lower recognition rate even with auditory training. In other words, the keywords for searching are present in PPT files and dialog contents, and the AV data corresponding to them will be found for playing. As shown in FIG. 6, different AV data may be simultaneously present in one PPT file so as to be played at the same time.

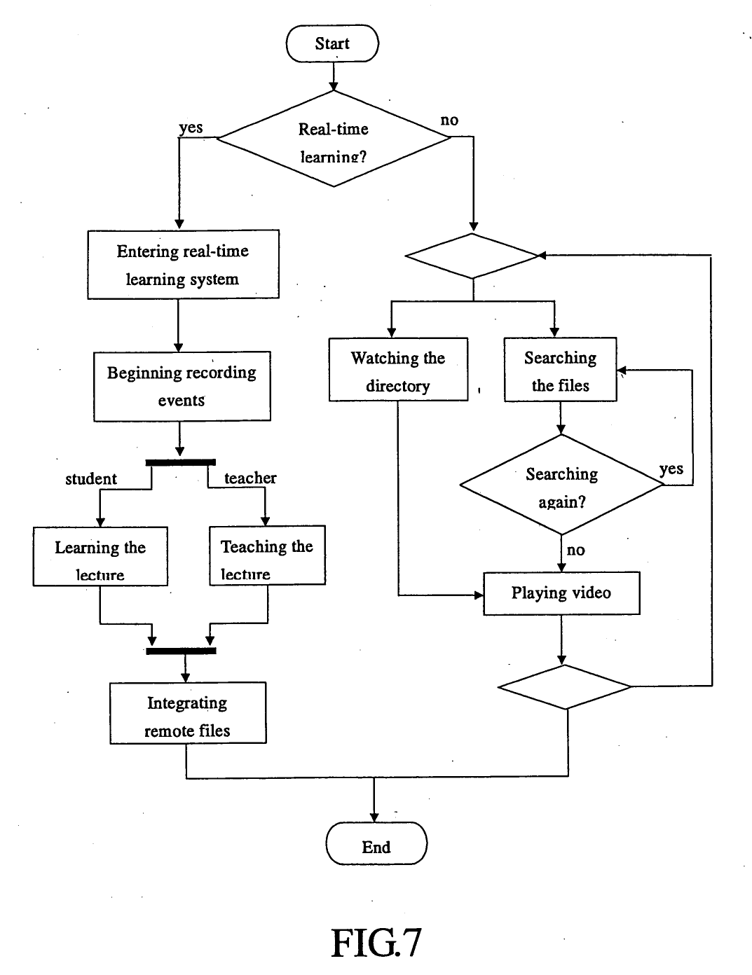

Referring to FIG. 7, the system of the present invention records and stores the real states through computer science, and further provides a function of data search. Accordingly, efficient learning can be achieved by common people and even the disable. Operation of this system is basically classified into real-time learning and non-real-time learning as follows:

(A) Real-time Learning

First, a user can select “real-time learning”, and the system will start recording. The user may be a teacher or a student having respective authorities. In general, the teacher has greater authority over the students and thus can keep order during lecturing. When the lecturing is finished, the system will automatically integrate remote files to complete the learning process.

(B) Non-Real-Time Learning

To help the students to supplement or correct lecture notes, the system provides the function of data search. Alternatively, the user can choose a chapter or section for reviewing. As a great feature of this system, data search facilitates the user to directly find the desired subject without playing da capo. The system can search related video section according to the keywords input by the user, which is similar to a searching engine of an entrance website. By automatically comparing with the keywords, the system can save a lot of labor cost.

When the lecture is finished, the system will immediately integrate all files lest all data become ineffective due to inefficacy in any node of the network. A virtual machine (VM) may serve as a data center to automatically analyze log files once finishing the lecture. Then all the RTP data accessed from respective AV servers are transformed into AVI files from packet queue files, and stored with player in one directory so as to be conveniently recorded on compact disks.

As mentioned above, the present invention can improve demerits of the video on demand (VOD) stream servers and the conventional AV software applied to e-learning or video conference; and further associate merits of synchronous and asynchronous real-time learning to promote quality of the AV system. In summary, the present invention provides advantages as follows:

1. Through the function of searching content, the user can select an interesting subject and review it by skipping to the correspondent point of time.

2. By means of genetic algorithm (GA), web load of the AV server and RTP parameters for each user can be optimized, so that RTP would not be lost due to overload of multicasting packages to the AV server; and also bandwidth would not be wasted and AV quality is promoted when less users are on line.

3. Through the synchronization control with time axis, all AV data recorded in different servers can be simultaneously played accompanied with all correspondent texts and figures used during lecture.

4. No extra software is installed as the system is preferably developed with Java language wherein Java Applet provides the function to set applications into web pages; and therefore only a browser is required for users.

5. Events such as shifting of people speaking, occurring at a certain point of time will be recorded in log files in XML format, which facilitates to access AV stream data from different AV servers due to self labeling of XML and exchange data of log files described in XML Schemal.

6. This system provides both functions of interactive learning on line and individual learning at different time, and the former can promote quality of service (QoS) by GA and record the real states.

7. The slides can be produced with Power Point and easily searched by users with accuracy.

While the present invention is illustrated with the preferred embodiment, those skilled in the art can accordingly make changes and modifications for specific requirements. Such changes and modifications may be made without departing from the scope and spirit of the invention as set forth in the following claims.

What is claimed is:

1. A multimedia learning system with digital archives, comprising a structure prototype of system data, a time axis, log files along the time axis, a counter and genetic algorithm (GA); the structure prototype of system data provides a programmer required files for clearly recording and storing real states in the system; the log files along the time axis are in XML format so as to conveniently communicate with other machines; the counter records events occurring at certain points of time; and the time axis assists different works to be executed simultaneously; wherein:
the structure prototype of system data transforms a real state of lecturing into data structure, in which images and voices can be constructed with RTP streams, a slide can be made with Microsoft Power Point, the user's instruction is defined as an event in said learning system, and these data are stored as video, audio, gif, html and log files;
the log file along the time axis is recorded in the XML format and comprises behavior of all participators;
the time axis provides a basis for recording points of time to start or end an audio/video data file in the log file, so that the audio/video data file can keep playing according to only a trigger signal of the counter even if be divided due to shifting slides;
GA provides a way to optimize parameters of RTP/RTCP, in which a main body or an instance represents a set of parameters of an AV server;
accordingly, when the counter counts to a certain point of time, an event loaded on the time axis will be presented through an independent thread; and a function of search is provided to search the audio/video data corresponding to an input keyword which exists in a dialog content and PPT files and correlation of PPT files is higher than that of the dialog content.
